(19) United States
(12) Patent Application Publication
(10) Pub. No.: US 2026/0102234 A1
(43) Pub. Date: Apr. 16, 2026

(54) Faucet Connector for Compatible Commercial Oral Irrigator Handles with a Locking Mechanism

(71) Applicant: Tianhao Ding, Lexington, MA (US)

(72) Inventor: Tianhao Ding, Lexington, MA (US)

(21) Appl. No.: 18/915,237

(22) Filed: Oct. 14, 2024

(51) Int. Cl. A61C 17/032

(52) U.S. Cl. CPC A61C 17/032

(57) ABSTRACT

The present invention provides a faucet connector system for compatible commercial oral irrigator handles, offering a non-electric alternative to traditional water flossers. The system includes a faucet diverter, bridge tubing, a flosser tip rest, a tip rest stop, a handle connector, and a retention cap. The handle connector uses mounting brackets and locking arms to secure the irrigator handle fitting, preventing disconnection under water pressure. The retention cap fits over the mounting bracket and locking arm to limit rotation and ensure stability. This modular design reduces electricity use, simplifies maintenance, and offers a cost-effective, efficient oral hygiene solution.

### RELATED APPLICATIONS

This application claims the benefit under 35 USC 119(e) of the U.S. Provisional Application No. 63/598,130, filed on Nov. 12, 2023, which is incorporated herein by reference in its entirety.

### FIELD OF THE INVENTION

The present invention relates to the field of oral water flossers or irrigators. More specifically, the invention relates to connecting Compatible Commercial Oral Irrigator Handles (CCOIH) to faucets, a feature that is not typically provided by existing electric oral irrigators.

### BACKGROUND OF THE INVENTION

The benefits of water flossing are widely recognized. The majority of people choose to use electric water flossers. Electric water flossers, such as those manufactured by leading brands, offer many advantages, such as easy installation and portability for travel. However, compared to water flossers that use faucet water, electric models rely on electricity to pump water from a built-in tank, which must be filled before use and cleaned regularly. They tend to be noisier in operation and may be more prone to breakdowns. Additionally, most, if not all, electric water flossers on the market do not offer the option to use faucet water directly.

### SUMMARY OF THE INVENTION

The present invention provides a novel solution for connecting a Compatible Commercial Oral Irrigator Handle (CCOIH) directly to faucet water, offering users an alternative to traditional electric water flossers. This invention is particularly beneficial for individuals who have a spare CCOIH, or a broken electric water flosser device with a still-functional water flosser handle. By allowing the handle to be connected directly to a faucet, users can bypass the need for an electric water flosser unit, reducing reliance on electricity and minimizing maintenance requirements. This innovation not only extends the usability of existing CCOIH but also provides a more convenient and cost-effective option for oral hygiene.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 provides an overall illustration of the invention, detailing the interconnected components that make up the system. The assembly begins with the faucet diverter (10), which directs water from the faucet into the system. Attached to the diverter is the bridge tubing (20), which carries water toward the flosser handle. Two components are mounted on the bridge tubing: the tip rest stop (30) and the tip rest (40), designed to hold a flossing tip along with the attached flosser handle when not in use. At the other end of the bridge tubing is the handle connector (50), which provides a secure connection for water flow to the handle. A retention cap (60) keeps the water flosser handle fitting securely attached onto the handle connector.

FIG. 2 illustrates a faucet diverter assembly, showing its principal components. The faucet mounting screw (10A) is located at the top, allowing for secure attachment to a faucet.

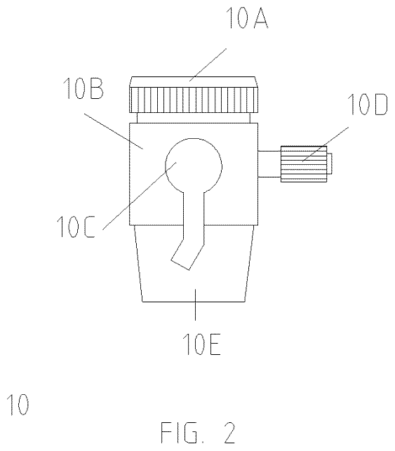

The diverter body (10B) forms the central housing, within which the internal water flow mechanism operates. A flow control handle (10C) enables the user to alternate water flow between the faucet water outlet (10E) and an auxiliary water outlet (10D). The auxiliary water outlet (10D), positioned on the side of the diverter, allows for attachment to devices such as a water flosser or hose.

FIG. 3 illustrates a plastic tubing clamp in its locked position, used as a flossing tip rest. The clamp features a clamping arm (40A) that grips and secures an object inside the clamp, and a latch (40B) that keeps the clamp securely closed. When locked, the clamp forms two holes (40C), each capable of serving one of two interchangeable roles: one can attach the clamp to plastic tubing, while the other can hold a flossing tip when not in use.

FIG. 4 illustrates a handle connector designed to connect a faucet diverter to a water flosser handle. It includes a barbed connector (50D) at the bottom, attached to a bridge tubing (20). At the top is a cylindrical female fitting (50A) that connects to the water flosser handle fitting (300) and also serves as a fluid channel, directing water from the faucet to the CCOIH.

Mounting brackets (50C) on either side hold the ears (300B) of the fitting. To keep the handle fitting (300) securely in place, two locking arms (50B) prevent axial movement and disconnection during use. This design ensures a stable, leak-free connection between the water flosser handle and the faucet.

FIG. 5 illustrates a retention cap (60) with an opening (60A), designed to prevent the water flosser handle fitting from spinning out of the mounting brackets (50C). When the retention cap is placed over both the mounting bracket and the locking arm (50B), it ensures that the ear of the fitting stays securely inside the mounting bracket and prevents it from rotating or becoming dislodged during use, providing a stable and reliable connection.

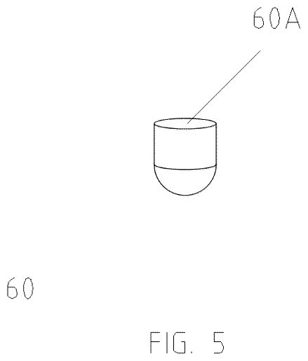

FIG. 6 illustrates the fitting (300), as referenced in U.S. Pat. No. 11,197,745 by inventors Brian Boyd, Brian R. Williams, and Kurt M. Taylor, designed for connecting a water flosser handle to an electric water flosser device. The fitting body (300A) is a cylindrical male component that securely inserts into the female fitting of the device's base unit. Two mounting ears (300B) extend from the fitting, each with a screw hole for secure attachment to the base unit using screws. A water outlet pipe (300C) extends from the fitting (300), allowing connection to the plastic tubing of the water flosser handle to maintain continuous water flow. An O-ring is installed at location (300D), ensuring a leak-proof seal at the connection. This fitting is commonly used in commercial water flossers and replacement kits.

FIG. 7 illustrates the assembly of the water flosser handle fitting (300), the handle connector (50), and the retention cap (60). The water flosser handle fitting (300) is inserted into the handle connector (50), and the retention cap (60) is placed over both the mounting bracket (50C) and the locking arm (50B) of the handle connector. This configuration ensures that the ear of the fitting (300) stays securely inside the mounting bracket, preventing rotation or dislodgement and securing the fitting in place.

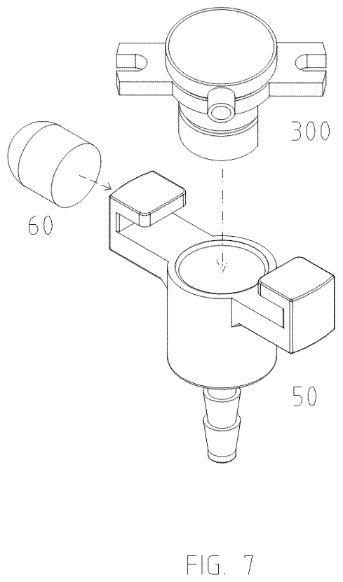

### DETAILED DESCRIPTION OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

The present invention is directed to a system and method for connecting a CCOIH directly to a faucet, thereby providing users with a versatile and efficient alternative to traditional electric water flossers. This invention addresses several common issues associated with electric water flossers, such as the reliance on electricity, the need for regular maintenance of a built-in water tank, and the operational noise typically associated with these devices.

In some households, users may have a spare CCOIH, or an electric water flosser that is no longer fully functional but its water flosser handle still works. The present invention allows these users to maximize the utility of their CCOIH by connecting them directly to a faucet, offering an alternative to the electric water flosser unit. This is accomplished through a specially designed connector that securely connects the handle to the faucet, enabling water to flow directly from the faucet through the handle and out through the flosser tip.

This innovative approach provides several key benefits. First, it eliminates the need for electricity, which not only reduces energy consumption but also allows for use in environments where electricity may not be readily available, such as in travel or camping situations. Second, it simplifies maintenance by removing the need for a separate water tank that requires frequent filling and cleaning. Third, the direct connection to a faucet results in a quieter operation compared to electric models, making the device more pleasant to use, particularly in quiet environments.

The embodiments of the invention are described in detail to demonstrate how the system and method can be implemented. However, it should be understood that the embodiments presented are merely examples, and variations may exist that fall within the scope and spirit of the invention. These embodiments provide further details on the structure and operation of the specially designed connector, as well as the overall system that enables the CCOIH to function seamlessly when connected to a faucet.

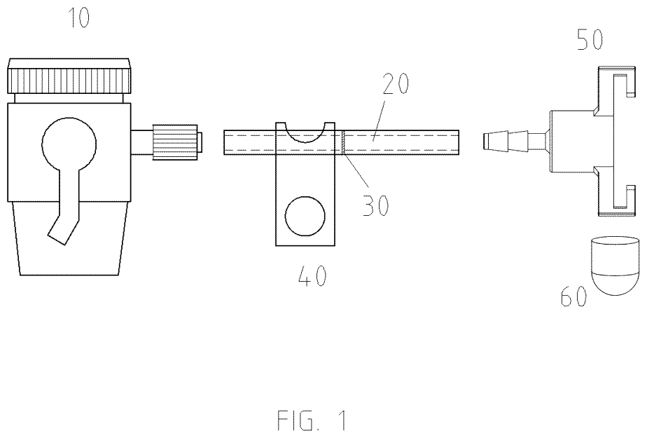

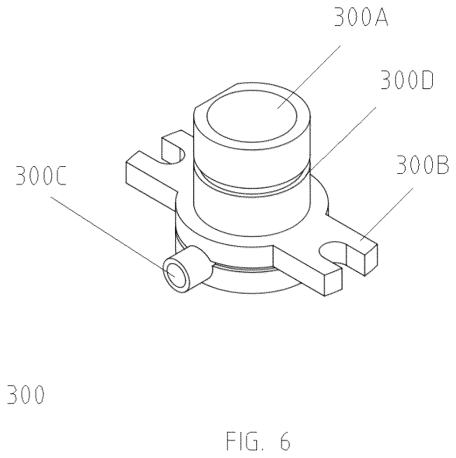

The current invention is illustrated in FIG. 1, according to one embodiment of the present disclosure, which may include a faucet diverter (10), bridge tubing (20), a tip rest stop (30), a tip rest (40), a specially designed handle connector (50), and a retention cap (60). In this embodiment, the handle connector (50) is a versatile design that can be applied in various configurations and applications, including connecting a Compatible Commercial Oral Irrigator Handle (CCOIH) with a fitting (300), as illustrated in FIG. 6 and discussed in detail in the following sections. Once the invention is assembled, with the diverter connected to a faucet and the handle connector attached to a CCOIH, the user can begin flossing by turning on the faucet and switching the diverter (10) to supply water through the auxiliary water outlet (10D). After use, the CCOIH can be placed in the tip rest (40), which is conveniently located near the faucet and above the sink.

In this embodiment, the faucet diverter (10) connects to the faucet and controls the water flow between the faucet water outlet (10E) and the auxiliary water outlet (10D). Bridge tubing (20) extends from the faucet diverter to the handle connector (50) to direct water toward the water flosser handle. The tip rest (40) holds the flossing tip along with the attached flosser handle when not in use. The tip rest stop (30) is an elastic ring that maintains the position of the tip rest and the water flosser handle, ensuring they remain in a convenient location. In this application, the terms “water flosser” and “oral irrigator” are used interchangeably to refer to devices designed for oral hygiene that deliver a stream of water for cleaning teeth and gums.

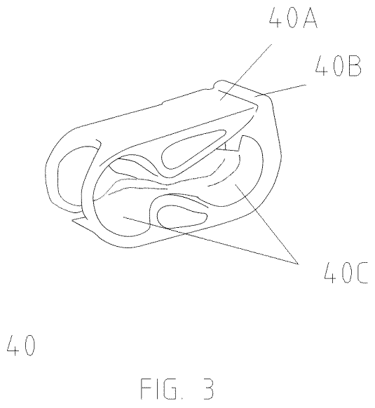

The tip rest (40), shown in FIG. 3, is a plastic tubing clamp in its locked position. It forms two holes (40C), each serving interchangeable roles: one secures the clamp to tubing, while the other holds a flossing tip when inserted. The tip rest is attached to the bridge tubing (20) near the faucet, positioned so any remaining water in the tip drips conveniently into the sink. An adjustable, elastic tip rest stop (30) ensures the tip rest and water flosser handle remain in a convenient position.

The handle connector (50) is a component that secures the water flosser handle. It consists of a cylindrical body that holds the handle fitting, mounting brackets to accommodate flange or fitting ears, and locking arms for stability. A retention cap fits over the mounting bracket and locking arm, preventing the handle from rotating or detaching under water pressure, ensuring a secure and reliable connection.

A Compatible Commercial Oral Irrigator Handle (CCOIH) is a replacement water flosser handle typically sold as part of a kit. It includes a reconnectable male fitting (300) that attaches to the female fitting on an electric water flosser, tubing that connects to the handle, and a tip for directing water flow. To replace the handle, a customer removes the two screws (316), unplugs the old fitting (300), plugs in the new fitting, and reattaches the screws. This modular design ensures easy replacement, maintenance, and compatibility, with alternative handle designs being uncommon on the market.

In another embodiment, the handle connector (50) features a simplified configuration with a single mounting bracket and a single locking arm to secure the water flosser handle fitting (300). In this design, the mounting bracket and locking arm are positioned on one side of the fitting, engaging with one of the ears (300B) to ensure a secure attachment. The retention cap (60) is placed over both the mounting bracket and the locking arm to keep the ear securely inside the mounting bracket, preventing movement and maintaining the fitting's stability under water pressure. This alternative configuration may offer a more compact solution while still providing effective retention for the water flosser handle.

The fitting (300), shown in FIG. 6, is described in U.S. Pat. No. 11,197,745, titled “Removable Fluid Connection Fitting for an Oral Irrigator.” This removable fitting (300) is coupled to a cylindrical female connector on the base unit of an electric water flosser and secured to the base unit with two screws (316). As part of the water flosser handle, this detachable fitting (300) is commonly found in several commercial electric water flossers as well as in commercial water flosser handles used as replacement parts. As the patent title suggests, the fitting is designed for easy removal and installation, allowing users to replace the handle when needed. It connects to a water flosser tip through tubing that directs water flow from the pump to the handle and tip, enabling oral irrigation. In the present application, no similar or conflicting claims are made with respect to any aspect covered by U.S. Pat. No. 11,197,745.

The design of the mounting bracket and locking arm offers great flexibility in accommodating the ears of the male fitting component, regardless of their shape. As long as the ears fit within the mounting brackets and the retention cap can be securely placed over both the mounting bracket and locking arm, the system functions effectively. Furthermore, this versatility allows the handle connector to support various fitting designs and accommodate a range of ear shapes and dimensions, making it adaptable to different configurations and applications.

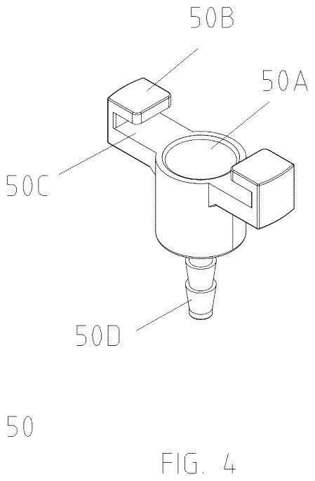

The present invention centers on the handle connector (50), as shown in FIG. 4, which connects a faucet diverter to a water flosser handle. The cylindrical fitting (50A) serves as a female component that securely connects to the water flosser handle fitting (300) and also functions as a water channel, directing flow from the faucet to the handle. Mounting brackets (50C) on either side hold the ears (300B) of the fitting in place. To ensure secure attachment, two locking arms (50B) prevent the handle fitting (300) from disconnecting under water pressure. Alternatively, the connector can be configured with a single mounting bracket and locking arm while still providing secure attachment. When the ears (300B) are positioned within the brackets and beneath the locking arms, an elastic retention cap (60) is placed over both the mounting bracket and locking arm to keep the fitting secure and prevent it from rotating or slipping out. This design ensures a stable, leak-free connection between the water flosser handle and the faucet. At the bottom of the connector is a barbed connector (50D) that attaches to the faucet diverter via bridge tubing (20).

It is common to use female and male connection couplings and a barbed stem as part of a tubing connection—for example, as seen in the now-expired U.S. Pat. No. 5,052,725. However, the novelty of the present invention lies in its unique fitting locking system, which offers simplicity in design and ease of assembly. The mounting brackets (50C) receive and secure the ears (300B) on the water flosser handle fitting (300), while the locking arms (50B) prevent the fitting from being pushed out under faucet water pressure. Additionally, the retention cap further ensures that the fitting (300) remains securely within the mounting brackets (50C) and locking arms (50B).

The invention provides a convenient solution for setting up and using a water flosser system with minimal assembly. For users of the invention, one configuration includes a pre-assembled set comprising a diverter (10), bridge tubing (20), a tip rest stop (30), a tip rest (40), and a handle connector (50), with a retention cap (60) provided separately. To use the system, the user inserts the water flosser handle fitting (300) into the cylindrical body (50A) of the connector (50) and rotates the fitting (300) so that the ears (300B) are positioned within the mounting brackets (50C) and beneath the locking arms (50B). The user then secures the setup by placing the retention cap (60) over both the mounting bracket and the locking arm to keep the fitting in place and prevent rotation or dislodgement during use. To disconnect the water flosser handle, the user simply reverses these steps.

What is claimed is:

1. A faucet connector system for connecting a water flosser handle, comprising:
a. a faucet diverter configured to direct water flow from a faucet;
b. bridge tubing extending from the faucet diverter to direct water towards the water flosser handle;
c. A handle connector including a cylindrical body that receives and securely connects a water flosser handle fitting, and serves as a fluid channel between the faucet and the fitting;
d. one or more mounting brackets attached to the handle connector configured to receive and secure one or more ears of the water flosser handle fitting; and
e. one or more locking arms on the handle connector to prevent the water flosser handle fitting from being pushed out due to water pressure.

2. The faucet connector system of claim 1, further comprising:
a. a retention cap placed over a mounting bracket and its corresponding locking arm to prevent the water flosser handle fitting from rotating within the handle connector.

3. The faucet connector system of claim 1, further comprising:
a. a tip rest attached to the bridge tubing to support a flossing tip and the water flosser handle when not in use.

4. The faucet connector system of claim 1, further comprising:
a. a tip rest stop made of an elastic material, adjustable along the bridge tubing, and configured to maintain the position of the tip rest and the water flosser handle.

5. A handle connector system for connecting a male fitting to a female connector, comprising:
a. a female connector including a cylindrical body designed to receive the male fitting and function as a fluid channel;
b. one or more locking arms, each forming part of a mounting bracket, with the mounting bracket configured to receive an ear of the male fitting, and the locking arm configured to hold the ear and fitting in place, preventing movement along the axial direction, regardless of the ear's shape;
c. a retention cap configured to fit securely over at least one locking arm and the corresponding mounting bracket to limit the rotational movement of the male fitting, the retention cap featuring an interlocking groove that engages with the locking arm to enhance stability and prevent unintentional disconnection;
d. a barbed connector configured to connect to a tube; and
e. an internal fluid channel that directs fluid from the barbed connector, through the cylindrical body of the female connector, and into the male fitting.

6. The handle connector system of claim 5, wherein the mounting bracket, locking arm, and retention cap are configured to accommodate fitting ears of various shapes and dimensions, with corresponding design adjustments to ensure secure engagement and maintain stability.

7. A method of using the handle connector system of claim 5, comprising:
a. inserting the male fitting into the cylindrical body of the female connector;
b. rotating the male fitting so that each ear of the fitting is positioned within a corresponding mounting bracket and beneath a corresponding locking arm; and
c. placing a retention cap over the mounting bracket and locking arm to prevent the fitting from rotating or becoming dislodged during use.

8. The method of claim 7, further comprising:
a. disconnecting the male fitting by removing the retention cap and rotating the fitting until its ears disengage from the mounting brackets and the locking arms;
b. removing the male fitting from the cylindrical body of the female connector.
